(19) United States
(12) Patent Application Publication
(10) Pub. No.: US 2012/0233549 A1
(43) Pub. Date: Sep. 13, 2012

(54) VIRTUAL DESKTOP INTEGRATION BASED ON PROXIMITY AND CONTEXT

(75) Inventor: Christopher Ricci, Cherry Hills Village, CO (US)

(73) Assignee: AVAYA INC., Basking Ridge, NJ (US)

(21) Appl. No.: 13/042,446

(22) Filed: Mar. 7, 2011

(51) Int. Cl. G06F 3/01; G06F 15/16

(52) U.S. Cl. 715/740

(57) ABSTRACT

A flexible Virtual Desktop Infrastructure is disclosed. In particular, mechanisms for determining location information for a client device and/or a usage context for the client device are provided. Based on the determined location and/or usage context a desktop profile may be selected from a plurality of desktop profiles mapped to the user of the client device for display by the client device.

### FIELD OF THE DISCLOSURE

The present disclosure is generally directed toward controlling the display of information on a client device.

### BACKGROUND

Today there is a strong movement toward the use of Virtual Desktop Infrastructure (VDI). VDI allows users to employ a simple client device (e.g., a device not having a hard disk and with limited memory/processing capabilities) as the desktop device. The main processing for a user's desktop, however, is implemented in a separate virtual machine running on a server. The server generates a desktop view and then provides the user's desktop to the client device, where it is displayed to the user. As the use of VDI proliferates, there is a need to merge VDI and traditional devices that are not virtualized.

### SUMMARY

It is with respect to the above issues that the embodiments presented herein were contemplated. This disclosure proposes, among other things, a client device that is capable of displaying two or more desktop profiles, one or more of which may be a VDI-based profile (e.g., a Virtual Desktop profile), and mechanisms for selecting which among the two or more desktop profiles should be presented to a user of the client device at any given time.

It is one aspect of the present disclosure to enable a selection mechanism that can determine the location of the client device and/or context of client device usage to select which among the two or more desktop profiles should be presented. Selection of desktop profiles does not, however, have to be mutually exclusive and multiple desktop profiles may be displayed simultaneously.

Today, a user may have a client device in the form of a smart phone that the individual uses when they are mobile. It is one aspect of the present disclosure to provide the client device with a push to VDI capability. With the push to VDI, the same user may now have a VDI desktop at work, instead of the traditional computer desktop/laptop computer. One problem with mobile smart devices and laptops is the security of the data stored upon them. If the user loses the device, the data on the device may be compromised. Moreover, if the device is damaged, the data may be lost. If the same device can support VDI, the advantage is that data is now stored on a secure server. The integration of Virtual Desktop technologies into these smart devices can provide secure access to business applications while still allowing the user to have access to standard features provided by the smart device.

One way to provide integration is to detect presence of the client device via wireless technologies such as Bluetooth, Wi-Fi, broadband, etc.; when the presence of the client device is determined, a hand-off between desktops/devices can be performed. A different desktop profile is used based on the context/presence of the client device. Both context and presence information can be broady defined and the input variables used to determine context and/or presence for a client device can vary greatly without departing from the scope of the present disclosure.

As a non-limiting example, if a user is talking on a client device as they drive to work, the client device may initially use the standard desktop profile which is generated and presented by the operating system of the client device. When the user arrives in the parking lot or proceeds to the office building at a destination, the client device detects the availability of Wi-Fi at the destination and determines that a trusted work network has been detected. Based on detecting the office network, the client device may immediately change the desktop profile to allow a Virtual Desktop display. Alternatively, an icon may be presented on the client device that, when selected, can bring up the Virtual Desktop, thereby providing access to confidential (secure) data from a server of the work network.

While at the destination, the user can duck into a conference room or sit in their car and complete the call now having access to the network data, but without having to download anything. Alternatively, if the user proceeds to their office, a dock located in the user's office may detect the client device's presence via Bluetooth and posts a hand-off popup on the monitor of either the mobile client device or an in-office client device. When the user becomes situated, the user presses OK in response to the hand-off popup and the call can then be transitioned from the mobile client device to the in-office client device.

Continuing the above example, once the call has been completed, the mobile client device may then receive a new desktop profile where it is a slave to the in-office client device. For example, if a call comes in from either the mobile client device or the land line of the user's office, the call can be answered using the in-office client device that displays a desktop profile native to the mobile client device. When the mobile client device is undocked and leaves the Wi-Fi/Bluetooth networks, the profile is switched back to the original profile of the mobile client device and the user loses access the applications/data in the Virtual Desktop.

In the slave mode, access to the original profile from the Virtual Desktop can be accomplished through an icon that is displayed on the Virtual Desktop. In the slave mode, if a call is received by the mobile client device (e.g., using the mobile client device's telephone number), the call can be displayed in the Virtual Desktop as if it were a regular call to the Virtual Desktop; or in the alternative, the Virtual Desktop could bring up a window that displays the desktop of the mobile client device within the Virtual Desktop environment.

Toggling between the original profile of the client device and the Virtual Desktop profile can also happen based on other types of context information. For example, if a user receives a call on their mobile client device and after accepting the call has docked their mobile client device with a docking station, the user may be using the Virtual Desktop profile. The profile may change back to the original desktop profile of the mobile client device (even while the mobile client device is docked) if a call is received at the mobile client device from a particular user (e.g., a call to the mobile client device phone number from the user's wife (home context)) may trigger a transition back to the original desktop profile or the mobile client device could simply ring even though VDI is currently being used and the Virtual Desktop profile is being displayed. Alternatively, the Virtual Desktop profile can be maintained and the call to the mobile client device can be answered via the Virtual Desktop.

Switching to/from the Virtual Desktop profile can be triggered in other ways such as based on GPS information, location within a building as determined using radio triangulation, broadband access, and the like. Moreover, a server may be able to provide multiple different Virtual Desktop profiles and switching between each of the profiles can be dependent upon location and/or context information determined for the client device.

In some embodiments, a system is provided that generally includes:

determining at least one of location and context information for at least one of a client device and a user of the client device;

mapping the at least one of location and context information to a desktop profile to be displayed by the client device; and

causing the client device to display the desktop profile.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting a plurality of client devices in communication with a server providing virtual desktop integration capabilities in accordance with embodiments of the present disclosure;

FIG. 3 is a block diagram depicting client device movement in accordance with embodiments of the present disclosure;

FIG. 4 is a state diagram depicting states and state-change-events used to control the display of a client device in accordance with embodiments of the present disclosure;

FIG. 5 is a block diagram depicting a data structure in accordance with embodiments of the present disclosure; and

FIG. 6 is a flow diagram depicting a process of controlling data displayed by a client device based on location and/or context in accordance with embodiments of the present disclosure.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any virtual desktop integration platform.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

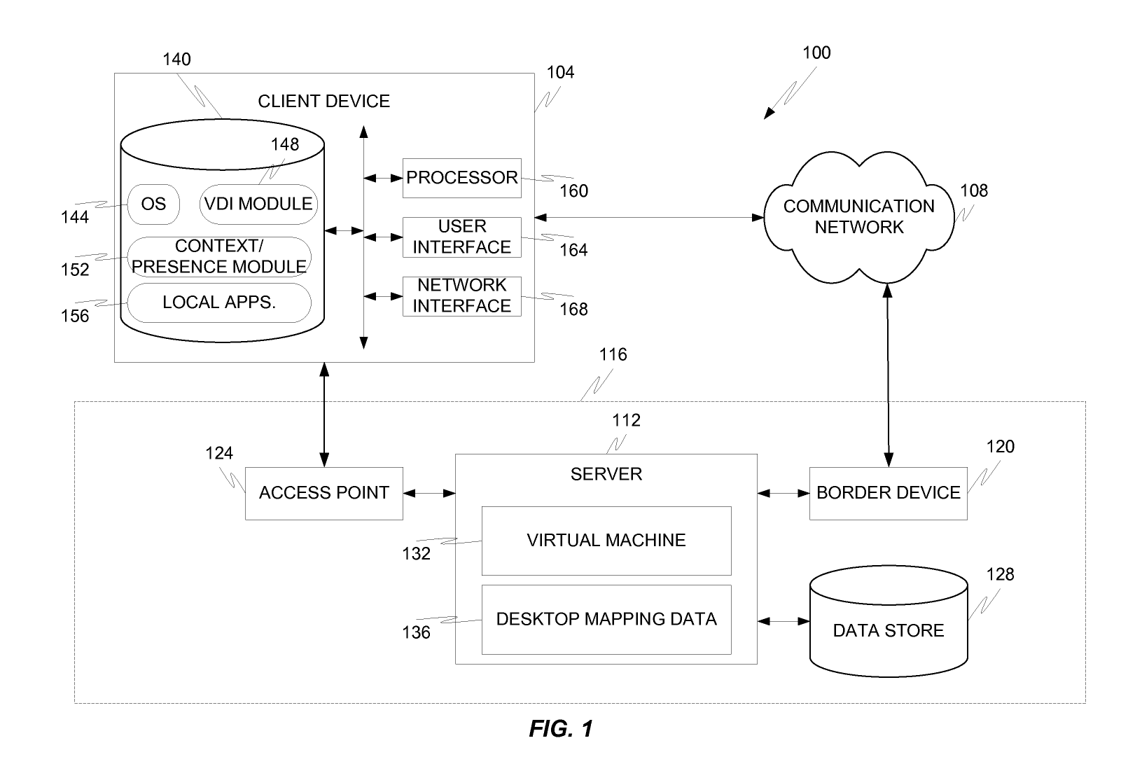

FIG. 1 depicts a communication system 100 according to an embodiment of the present disclosure. The communication system 100 may include an enterprise network (or other type of secured network) 116 that is in communication, via a (typically un-trusted or unsecure or public) communication network 108, with one or more client devices 104. Exemplary types of client devices 104 include, without limitation, cellular phones, smart phones, thin clients, laptops, tablets, Personal Computers (PCs), netbooks, Personal Digital Assistants (PDAs), digital phones, analog phones, docking stations for any of the above, and the like.

The communication network 108 may be packet-switched and/or circuit-switched. An exemplary communication network 108 includes, without limitation, a Wide Area Network (WAN), such as the Internet, a Public Switched Telephone Network (PSTN), a Plain Old Telephone Service (POTS) network, a cellular communications network, or combinations thereof. In one configuration, the communication network 108 is a public network supporting the TCP/IP suite of protocols. The communication network 108 may actually comprise a plurality of networks, some of which are secured networks and some of which are unsecured.

The enterprise network 116 may include a border device 120, a server 112 including one or more virtual machines 132 and data for mapping desktop profiles to users 136, one or more network access points 124, and a data store 128. In some embodiments, the various components of the enterprise network 116 are interconnected by a (trusted or secure or private) Local Area Network (LAN). Some or all of the functions depicted in FIG. 1 may be co-hosted and/or co-resident on a single server, may be shared between the server 112 and client device 108, and/or may be hosted on a plurality of different servers either within the enterprise network 116 or among a plurality of different enterprise networks. The depiction of components in FIG. 1 is generally intended to be a logical depiction of the components of the system 100.

The LAN of the enterprise network 116 can be secured from intrusion by untrusted parties by a gateway and/or firewall located between the LAN and communication network 108. In some embodiments the border device 120 may include the functionality of the gateway and/or firewall. In some embodiments, a separate gateway or firewall may be provided between the border device 120 and the communication network 108.

The server 112 can include a Private Branch eXchange (PBX), an enterprise switch, an enterprise server, combinations thereof, or other type of telecommunications system switch or server. Although only a single server 112 is depicted in FIG. 1, two or more servers 112 may be provided in a single enterprise network 116 or across multiple separate LANs owned and operated by a single enterprise, but separated by a communication network 108. In configurations where an enterprise or an enterprise network 116 includes two or more servers 112, each server 112 may comprise similar functionality, but may be provisioned for providing its features to only a subset of all enterprise users. In particular, a first server 112 may be authoritative for and service a first subset of enterprise users whereas a second server 112 may be authoritative for and service a second subset of enterprise users, where the first and second subsets of users generally do not share a common user.

Alternatively, or in addition, multiple servers 112 can support a common user community. For example, in geo-redundant and other applications where users aren't necessarily bound to a single server, there may be a cluster of equivalent servers where a user can be serviced by any server in the cluster.

In some embodiments, the server 112 may utilize the virtual machine 132 and/or desktop mapping data 136 to provide different desktop profiles to a client device 104. In some embodiments, the desktop profile provided to a particular client device 104 may be dependent upon the user using the client device 104, the location and/or context information that is currently determined for the client device 104, and any other security-relevant data. Sources of data for the location and/or context information may include the client device 104, the access point 124, the border device 120, the data store 128, any other communication device residing between the client device 104 and server 112, and/or any communication device to which either the client device 104 or server 112 has subscribed to for purposes of obtaining presence information about the client device 104.

As an example, the server 112 may utilize the virtual machine 132 to host a desktop operating system on behalf of the client device 104. This practice is known as a Virtual Desktop Interface or “VDI”, which is a variation on the client/server computing model that separates the personal computer desktop environment from a physical machine. More specifically, VDI is a centralized desktop delivery solution that enables an organization hosting the enterprise network 116 to store and execute desktop workloads (e.g., operating systems (OSs), applications, data, etc.) on the virtual machine 132. The server 112 may then present the user interface via a Remote Desktop Protocol (RDP) to the client device 104. With VDI, the OS can be decoupled from the client device 104. Thus, even though the client device 104 is depicted as comprising an OS 144 in memory 140, the client device 104 does not necessarily need to have an OS 144. If the client device 144 does have an OS 144, however, then the VDI provided by the server 112 can supplement the desktop profile natively provided by the OS 144 with a different desktop profile that is specific to the enterprise network 116, for example.

In some embodiments, the client device 104 comprises local memory 140, a processor 160, a user interface 160, and a network interface 168. The local memory 140 may be volatile or non-volatile. More specifically, the local memory 140 may comprise one or more of a ROM, PROM, EPROM, EEPROM, Flash memory, FeRAM, MRAM, PRAM, DRAM (e.g., DDR SDRAM), SRAM, or combinations thereof.

One or more sets of instructions may be stored in memory 140 and the instructions may be executed in a known fashion by the processor 160. As a non-limiting example, the instructions stored in memory 140 may include the OS 144, a VDI module 148, a context/presence module 152, and other local applications 156. The OS 144 may comprise a high-level application which enables user navigation and interaction with the other location applications 156 and/or VDI module 148.

In some embodiments, the VDI module 148 comprises an application which enables the client device 104 to establish a connection with server 112 and request a remote desktop connection. More specifically, the VDI module 148 may comprise instructions for establishing a connection with server 112 as well as requesting, receiving, and presenting virtual desktop profiles at the client device 104 where such virtual desktop profiles are generated by the virtual machine 132 and transmitted to the client device 104 using an RDP.

The context/presence module 152 may comprise instructions for determining location and/or context information for the client device 108. The context/presence module 152 may also comprise instructions for formatting and transmitting such information to the server 112. The context/present module 152 may also comprise instructions for comparing location and/or context information with the desktop mapping data 136 to determine which desktop profile is available or required for display via the client device 104. Depending upon the functionality required of the context/presence module 152, the context/presence module 152 may reside entirely on the client device 104, entirely on the server 112, partially on the client device 104 and partially on the server 112, and/or partially on some other component of the system 100.

In some embodiments, the context/presence module 152 may comprise or have access to a Global Positioning System (GPS) within the client device 104 to determine physical location information for the client device 104. In some embodiments, the context/presence module 152 may be configured to subscribe to a presence service which reports to the context/presence module 152 the current presence information for the client device 104. In some embodiments, the context/presence module 152 may comprise tools for analyzing a user's interaction with the client device 104 to determine a context (e.g., remote work context, in-office work context, meeting context, personal context, vacation context, traveling context, etc.) in which the client device 104 is being used.

It should be appreciated that context and/or location information can be determined in a number of different ways and the input variables used to determine such information can vary depending upon the types of data sources available to the context/presence module 152. For instance, location information can be one or more of latitude/longitude information obtained from a GPS module, latitude/longitude information obtained via cellular triangulation, position obtained based on network connection, position based on access point 124 connection, and so on.

The local applications 156 are any other application locally available on the client device 104. Exemplary local applications 156 includes, without limitation, web-browsing applications, word-processing applications, communication applications, texting applications, email applications, etc.

The processor 160 may be any type of known processor or set of processors. In some embodiments, the processor 160 may comprise one or more Integrated Circuits (IC), a Central Processing Unit (CPU), a microprocessor, or the like. It should be appreciated, however, that as an alternative to the processor/memory architecture, one or more Application Specific Integrated Circuits (ASICs) may be provided to perform functions of the VDI module 148, context/presence module 152, and other modules/applications of the client device 104.

The user interface 164 may include at least one user input device, at least one user output device, or one or more combination input/output devices. Examples of suitable user input devices which may be included in the user interface 164 are a keypad, a mouse, a trackpad (resistive, capacitive, pressure sensitive, etc.), an optical finger navigation system, a video camera, a still-image camera, a microphone, and the like. Examples of suitable user output devices which may be included in the user interface 164 are a display screen, a light, a single Light Emitting Diode (LED), an array of LEDs, a seven-segment LED display, a speaker, and the like. One example of a suitable combination input/output device is a touch-screen.

The various desktop profiles may be presented to the user of the client device 104 via the user interface 164 and the user may be allowed to interact with the same via the user interface 164. The display of each desktop profile on the user interface 164 may vary depending upon the desktop profile and the data used to generate the same. In some embodiments, one desktop profile may have a first set of icons, files, and/or data displayed therewith whereas another desktop profile may have a second set of icons, files, and/or data displayed. It may be that icons, files, and/or data common to both desktop profiles may be located in the same area of the user interface (e.g., at the same position of a screen), thereby minimizing the possible distraction associated with switching from one desktop profile to another. More specifically, if an icon, file, and/or data is displayed in both a first and second desktop profile, that same icon, file, and/or data may be displayed similarly in both desktop profiles even if one desktop profile is locally generated (e.g., generated by the OS 144) whereas the other desktop profile is a virtual desktop profile. These display characteristics may be provisioned by the user and defined in the desktop mapping data 136.

The network interface 168 provides the physical components for connecting the client device 104 to the communication network 108 and/or access point 124. In some embodiments, the network interface 168 is capable of facilitating wired and/or wireless communications with other computing devices. Specifically, the network interface 168 may comprise one or more of a wireless network adaptor (e.g., Wi-Fi, Bluetooth, etc.), an Ethernet card and port, a USB port, drivers for the same, and/or any other type of network port or adaptor configured to connect the client device to the communication network 108 and/or access point 124.

As noted above, a client device 104 does not necessarily need to have an OS 144. A client device 104 not having an OS 144 may instead only have a Basic Input/Output System (BIOS) that leverages a web-browsing application to search and interact with the local applications 156 as well as other servers connected to the communication network 108 using traditional web-browsing protocols (e.g., http, https, and known or yet to be developed variants thereof). Thus, the web-browsing application may serve as a proxy for the traditional OS. In such an embodiment, the client device 104 may be provided with a virtual desktop profile from server 112 or it may have the web-browsing application act as the other desktop.

Furthermore, the user of the client device 104 may have the ability to simultaneously or sequentially work with a number of different desktop profiles on the client device 104. In particular, some desktop profiles presented to the user on the client device 104 may be generated by the OS 144 (or a web-browsing application) and be presented in the normal fashion. Other desktop profiles presented to the user on the client device 104 may be generated by the virtual machine 132 and provided to the client device 104 via an RDP (e.g., virtual desktop profiles). Location and/or context information determined for the client device 104 may be used as an input in determining which desktop profile(s) can be presented by the client device 104, which desktop profile(s) should be presented by the client device 104, and which desktop profile(s) must be presented by the client device 104.

In some embodiments, the server 112 may comprise or have access to a data structure which maps users/locations/contexts to a virtual desktop profile. This data structure is generally referred to as the desktop mapping data 136 and although it is depicted as residing on server 112 it may alternatively, or additionally, reside in data store 128. The desktop mapping data 136 may be in any known structure (e.g., table, pivot table, chart, decision tree, set of pointers and chunks of data, etc.). The desktop mapping data 136 may comprise the data needed to map a particular user, his/her client device 104, and location/context information determined for the client device 104 to a particular desktop profile. In some embodiments, the desktop mapping data 136 may be used to identify whether a virtual desktop profile should be provided to the client device 104 or not. In some embodiments, the desktop mapping data 136 may be used to identify which among a plurality of possible virtual desktop profiles should be generated by the virtual machine 132 and be provided to the client device 104. In particular, a single user may be provisioned a plurality of virtual desktop profiles (all of which can be stored in the data store 128). Depending upon the location and/or context determined for the user's client device 104 at any given time, one or more of the possible virtual desktop profiles may be selected and provided to the client device 104.

As noted above, the virtual machine 132 may be responsible for generating a virtual desktop profile, but the data used to generate the desktop profile for a particular user may be obtained from the data store 128. Differences between virtual desktop profiles for a single user may vary only by the amount of data that is used from the data store 128 to generate the virtual desktop profile. More specifically, in a first mapping (for a first determined location and/or context) a first virtual desktop profile may be generated where all data usually available to the user in the data store 128 (e.g., including sensitive and non-sensitive data such as passwords, user names, social security numbers, employee information, client information, etc.) is used to generate the first virtual desktop profile. This first virtual desktop profile may correspond to a full display where the client device 104 is determined to be in a safe location and trusted context (e.g., physically within borders of the enterprise network 116 and connected to server 112 via access point 124 without going through border device 120) In a second mapping (for a second determined location and/or context) a second virtual desktop profile may be generated where less than all data available to the user in the data store 128 (e.g., only non-sensitive data or only specific types of sensitive data) is used to generate the second virtual desktop profile. This second virtual desktop profile may correspond to a partial display where the client device 104 is not within a safe location or context (e.g., the client device 104 is connected to server 112 through border device 120 rather than through access point 124 or a non-trusted user is detected within proximity of the client device 104).

Location and/or context for a client device 104 can be determined in a number of ways with data from a number of different sources. In some embodiments, the location and/or context for the client device 104 may depend upon the connection established between the client device 104 and server 104. Specifically, if the client device 104 is within the enterprise network 116, then the client device 104 may be capable of connecting to the server 112 via access point 124. When such a connection is established between the client device 104 and server 112, then a first location and/or context may be determined for the client device 104.

Alternatively, if the client device 104 is not within proximity (e.g., not within wireless transmission range of the access point 124 or able to physically connect to access point 124) of the enterprise network 116 and not able to connect directly thereto, then the client device 104 may need to connect to the server 112 via communication network 108 and border device 120. When this type of connection is established between the client device 104 and server 112, then a second location and/or context (different from the first location and/or context) may be determined for the client device 104.

It may also be possible for the client device 104 to connect to server 112 via both access point 124 and border device 120. Detection of such a connection may correspond to a third location and/or context for the client device 104 and may justify the display of a third desktop profile (either native to the client device 104 or virtual).

As can be appreciated, the enterprise network 116 may comprise a plurality of access points 124 located through a premises that contains the enterprise network 116. In some embodiments, location and/or context information can vary depending upon which access point 124 the client device 104 is connected to. Thus, a fourth, fifth, sixth, etc. different desktop profile (either native to the client device 104 or virtual) can be determined depending upon the location of the client device 104 within the enterprise network 116. More specifically, a fourth virtual desktop profile may be provided by the virtual machine 132 if the client device 104 is detected in a user's office whereas a fifth desktop profile may be provided by the virtual machine 132 if the client device 104 is detected in a conference room or shared area of the enterprise network 116.

The access point 124 may correspond to a wired or wireless access point that connects to the LAN of the enterprise network 116 and enables the client device 104 to connect to the server 112 according to the security parameters administered within the enterprise network 116. In some embodiments, the access point 124 may correspond to an 802.11x-based (e.g., 802.11b, 802.11a, 802.11g or 802.11n) router. In some embodiments, the access point 124 may correspond to a physical LAN connection, such as an Ethernet port or any other port which enables the client device 104 to connect to the LAN using standards such as token ring, FDDI, ARCNET, and the like. In some embodiments, the access point 124 may facilitate both wired and wireless connections to the LAN of the enterprise network 116. In some embodiments, the access point 124 may correspond to a docking station for the client device 104. Alternatively, or in addition, the docking station 124 may comprise a separate computing device to which the client device 104 connects using known proximity-based data exchange protocols (e.g., Bluetooth).

As discussed above, the desktop mapping data 136 may be used to map location and/or context information to a virtual desktop profile. The logic which compares the location and/or context information with the desktop mapping data 136 may reside on the server 112, in client device 104, or in any other device. Similarly, the logic which determines the location and/or context information for the client device 104 may reside on the server 112, in client device 104, or in any other device. In some embodiments, a context/presence module 152 may be provided as the logic to determine the location and/or context information for the client device 104. The context/presence module 152 may also be responsible for comparing such information to the desktop mapping data 136.

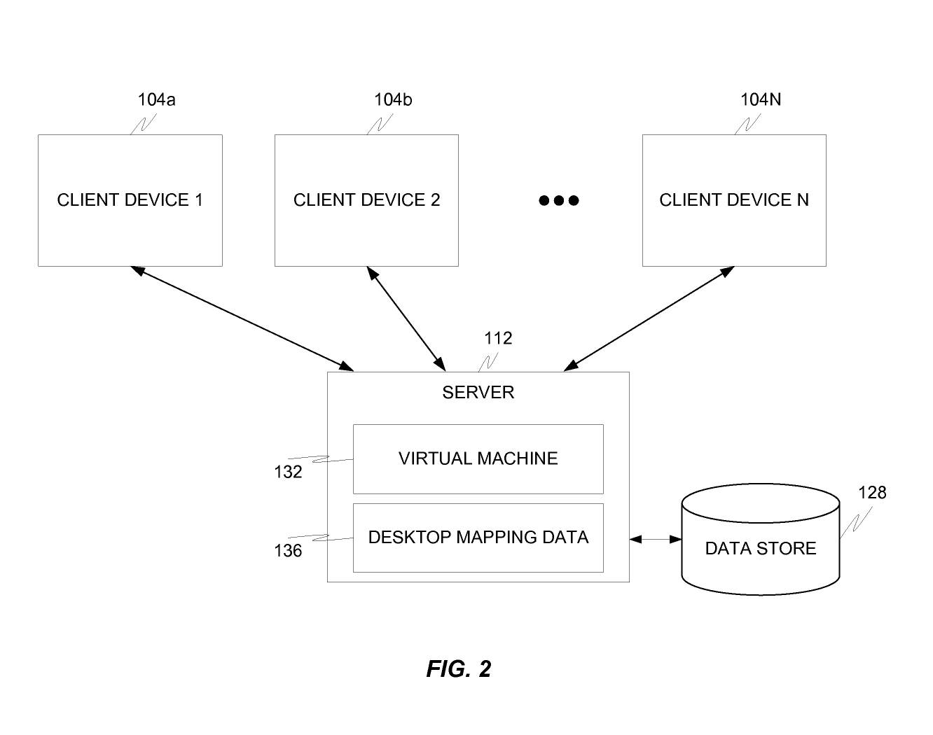

With reference now to FIG. 2 an alternative system configuration is depicted whereby a plurality of client devices 104a-N are configured to connect to the server 112 and receive virtual desktop profiles therefrom. In some embodiments, the client devices 104a-N may be owned and operated by different users. Alternatively, two or more of the client devices 104a-N may be owned and operated by the same user. Each client device 104a-N may be provided with a different virtual desktop profile by the server 112 and the properties of any virtual desktop profile provided to a user's client device 104 may depend upon the data contained in the desktop mapping data 136. In some embodiments, it may be possible to transfer a virtual desktop profile from one client device (e.g., the first client device 104a) to another client device (e.g., the second client device 104b) when the appropriate location and/or context information is received indicating that a user has switched from one client device to another. Alternatively, if two or more client devices 104 are detected as being within a predefined proximity (e.g., Bluetooth transmission range) to one another, then such information can be included in the location and/or context information for one or both client devices 104. The server 112 can then use this information to send a particular virtual desktop profile to both client devices or to send specific different virtual desktop profiles to both client devices.

As a more specific example, if a user walks into their office with their mobile phone (e.g., first client device 104a) and the user's work desktop computer or docking station (e.g., second client device 104b) detects the mobile phone, then one desktop profile may be provided to the mobile phone whereas another desktop profile may be provided to the computer or docking station. Alternatively, if before the user walked into their office they were viewing a virtual desktop profile on their mobile device, that virtual desktop profile may be handed off to the computer or docking station and the mobile device may be allowed to display a local desktop profile or some other virtual desktop profile.

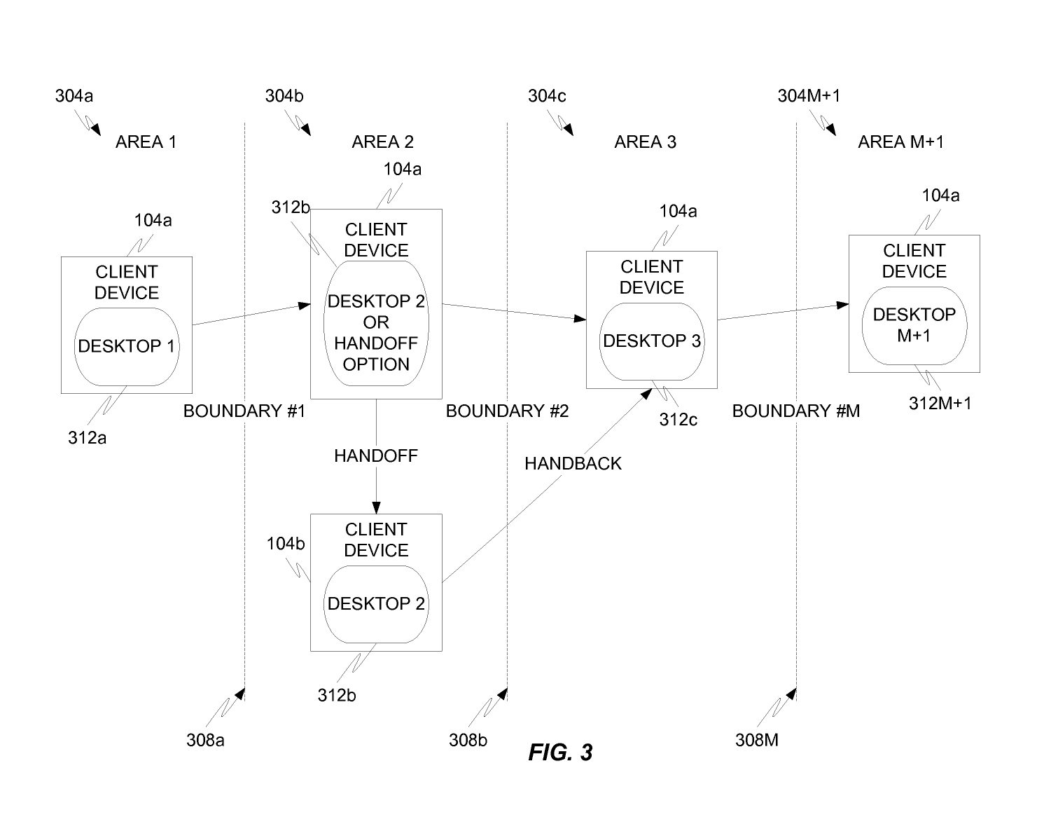

The method of switching desktop profiles presented on one or more client devices 104 will be described in further detail with respect to FIG. 3. In particular, one type of data that may be used to automatically cause a client device 104 to display a different desktop profile via its user interface 164 is location data. As can be seen in FIG. 3, a first client device 104a may initially be located in a first area 304a. The manner in which the location data is obtained to prove that the first client device 104a is in the first area 304 may vary depending upon the capabilities of the first client device 104a, the location of the context/presence module 152, and the types of network connections that the first client device 104a has established. While the first client device 104a is in the first area 304a, the first client device 104a may display a first desktop profile 312a. The first desktop profile 312a may correspond to a desktop generated by the OS 144 or the virtual machine 132. In other words, the first desktop profile 312a may be a native desktop profile or a virtual desktop profile. Furthermore, the data presented by the first desktop profile may depend upon the information known about the first area 304a (e.g., whether the first area 304a is a trusted area, within the enterprise network 116, and other considerations).

As the user of the first client device 104a moves, the first client device 104a may cross a first boundary 308a which separates the first area 304a from the second area 304b. Upon receiving location information which indicates that the first client device 104a has moved into the second area 304b, the first client device 104a may display a second desktop profile 312b. The switch from the first desktop profile 312a to the second desktop profile 312a may be triggered automatically or it may only trigger an automated query which asks the user if they want to display the new desktop profile. If the switch is automatic, then the first client device 104a may immediately begin displaying the second desktop profile 312b along with or instead of the first desktop profile 312a.

As an alternative, or in addition, to switching the desktop profile displayed on the first client device 104a, a handoff option may be made available to the user of the first client device 104a. The handoff option may allow the second desktop profile 312b to be presented on a second client device 104b that is also within the second area 304b. Like the options for switching the desktop profile displayed by the first client device 104a, the handoff may also be automatically invoked or may only be invoked upon user approval.

In some embodiments, two alternative icons may be presented within the first desktop profile 312a when the first client device 304a moves into the second area 304b. Specifically, one icon, if selected, may trigger the first client device 104a to begin displaying the second desktop profile 312b either alone or along with the first desktop profile 312a. The other icon, if selected, may trigger the first client device 104a to handoff the second desktop profile 312b to the second client device 104b. This handoff would allow the first client device 104a to continue displaying the first desktop profile 312a while the second client device 104b displays the second desktop profile 312b.

One non-limiting example of how the handoff feature may work is when a user enters his/her work space within an office complex. That work space may correspond to the second area 304b and the second client device 104b may be a PC, fixed-position work station, docking port, phone, etc. that is plugged into a wired access point 124. The first client device 104a, on the other hand, may correspond to a cellular phone, mobile phone, or the like that is (i) wirelessly connected to an access point 124 (not necessarily the same as the access point to which the second client device 104b is connected), (ii) connected to the server 112 via communication network 108, or (iii) only connected to communication network 108, such as a cellular communication network. Upon detecting the presence of the first client device 104a in the second area 304b, the handoff option may either be automatically executed or the options for handoff may be presented to the user.

As can be appreciated, the second desktop profile 312a may either be generated by the OS 144 or the virtual machine 132. In embodiments where both the first and second desktop profiles were virtual, the data displayed in the first desktop profile 312a may differ from the data displayed in the second desktop profile 312b or the organization of the same data may differ. The differences between the first and second desktop profiles may be administered either by the user of the client devices or an administrator of the server 112.

In an alternative handoff option, the second desktop profile 312b may be similar to the first desktop profile 312a except that the first client device 104a hands its display off to the second client device 104b. More specifically, if a user is engaged on a call with the first client device 104a, the call information (e.g., caller identification information, time of call, length of call, call options (e.g., hold, mute, conference, record, and so on), bridge appearance, contacts, call history, etc.) related to the call may be used to generate the second desktop profile 312b, which is handed off to the second client device 104b. Thus, the user can engage in the call on either the first client device 104a, the second client device 104b, or both client devices. Moreover, other data related to the call not available to the OS 144 but available to the virtual machine 132 (e.g., data stored in data store 128) may be presented to the user via the second desktop profile 312b. This allows the user to enhance the call experience by having the first desktop profile 312a displayed on the first client device 104a and the second desktop profile 312b displayed on the second client device 104b where both the first and second desktop profiles display different information about the call.

If the first client device 104a is detected as moving back into the first area 304a the first desktop profile 312a may then be re-displayed on the first client device 104a. Alternatively, if the first client device 104a crosses a second boundary 308b and moves into a third area 304c, a third desktop profile 312c may be displayed. If the second desktop profile 312b was being displayed on the second client device 104b when the first client device 104a leaves the second area 304b, the second client device 104b may discontinue its display of the second desktop profile 312b either by completely discontinuing its display or by handing the desktop display back to the first client device 104a. It should be appreciated, however, that if both the first and second client devices 104a, 104b are both mobile, then the second client device 104b may move into a different area and begin displaying a different desktop profile.

There may be up to M different boundaries and M+1 different areas. If the first client device 104a crosses the Mth boundary 308M into the last area 304M+1, then the first client device 104a may display desktop profile 312M+1. As can be appreciated by those of skill in the communication arts, if more areas are defined with different desktop profiles associated therewith, then more display properties for each of the areas will have to be defined.

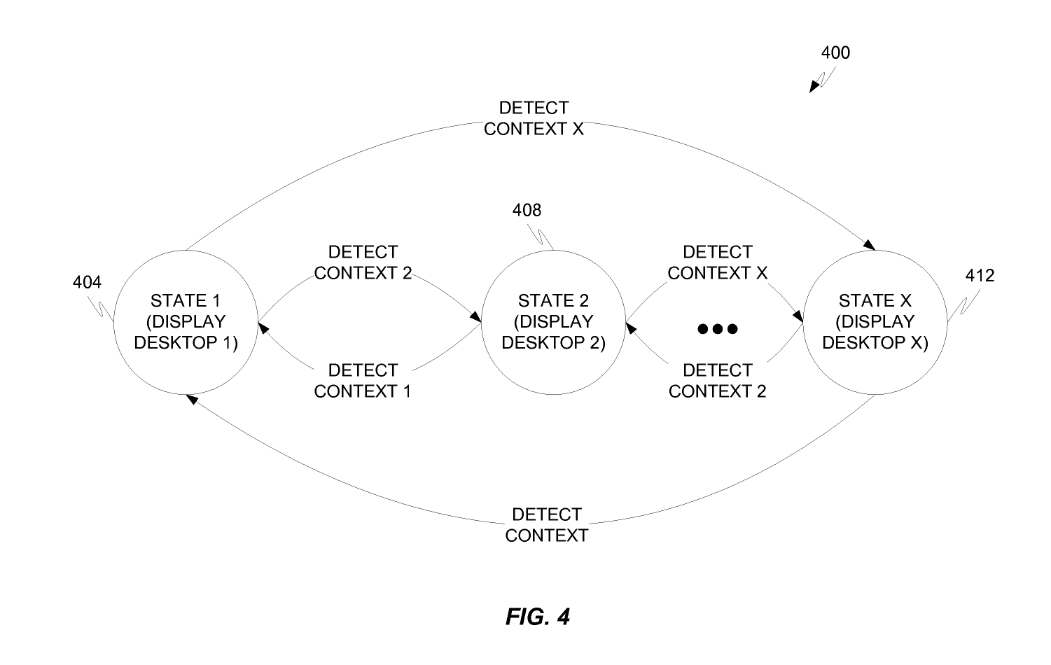

With reference now to FIG. 4, a state diagram 400 which defines rules and states for switching desktop profiles displayed on a client device 104 will be described in accordance with at least some embodiments of the present disclosure. As noted above, location, context, presence, and other types of data may be used to trigger a client device 104 to switch between desktop profiles. In some embodiments, location information alone may be used to define the states and, therefore, control when the client device 104 switches between desktop profiles. In some embodiments, context information alone may be used to define the states and, therefore, control when the client device 104 switches between desktop profiles. In some embodiments, presence information alone may be used to define the states and, therefore, control when the client device 104 switches between desktop profiles. In some embodiments, a combination of location, context, and presence information may be used to define the states and, therefore, control when the client device 104 switches between desktop profiles. In some embodiments, context information can be determined based on a number of input data sources including client device location information, user presence information, information about usage of the client device (e.g., which applications 156 are open and actively being used, what types of network connections are established with the client device 104, etc.), information about whether other people are in proximity of the client device 104 and if such people are identified and trusted by the enterprise network 116, information regarding the user's communication history, information regarding the user's contacts, and other information pertinent to security and trust. Thus, the context states depicted and described in connection with the state diagram 400 may represent the analysis of small or large amounts of data depending upon how the states have been defined and the desktop profile display rules have been administered.

In particular, a plurality of states may be defined including a first state 404, a second state 408, up to an Xth state 412. It should be appreciated that X may be any number greater than or equal to two.

The states may be defined within the context/presence module 152, may be made available to the context/presence module 152 by another application 156, may be defined within the desktop mapping data 136, and/or may be stored in the data store 128. The context/presence module 152 may utilize the state information to determine when a new context of use exists for the client device 104 and if such a new context requires a new desktop profile (or at least an option of displaying a new desktop profile).

More specifically, each state may have a desktop profile associated therewith. Thus, if the context/presence module 152 determines that the user device 104 is in the first context state 404, then the first desktop profile may be displayed on the user device. If a different context is detected, then a different desktop profile may be automatically displayed or at least an option to display a different desktop profile may be provided to the user of the client device 104.

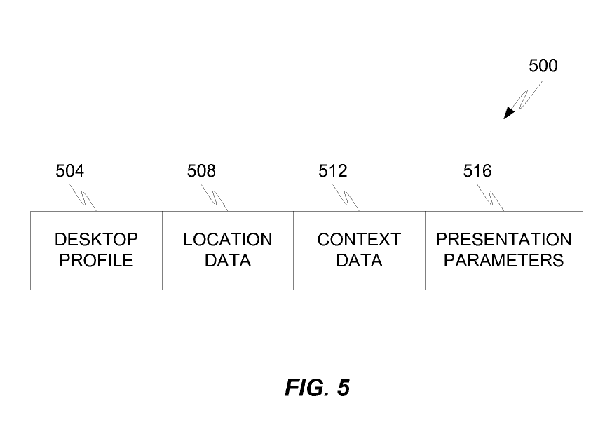

With reference now to FIG. 5, one example of a data structure 500 will be described in accordance with at least some embodiments of the present disclosure. The data structure 500 may be partially or completely included in the desktop mapping data 136, the data store 128, as a data structure in the context/presence module 152, or the like. In some embodiments, the data structure 500 is used to control when the client device 104 switches between desktop profiles. It may also be used to control what type of data is presented by a desktop profile and how such data is presented. Moreover, the state diagram 400 may be defined, in part or toto, with data from the data structure 500.

In some embodiments, the data structure 500 may comprise a number of data fields which help define the various desktop profiles that can be displayed for a user or a collection of users. The data fields may also contain data which defines when each of those desktop profiles should be displayed and how they should be displayed. More specifically, the data structure 500 may comprise a desktop profile field 504, a location data field 508, a context data field 512, and a presentation parameters field 516. Each data field may be configured to store one or more data values, variables, vectors, pointers, equations, Boolean expressions, and/or objectives.

In some embodiments, the desktop profile field 504 can be used to store information which identifies a particular desktop profile, whether the profile is virtual or generated by the OS 144. The desktop profile field 504 may also comprise information which maps a user to the desktop profile.

The location data field 508 may comprise information or variables for identifying the areas 304 or more specifically the boundaries 308 between areas 304. The location data field 508 may also comprise information which maps a particular location to a particular desktop profile. For instance, every instance of a desktop profile for a particular user may have a specific set of location data associated therewith. Such location data may be stored in the location data field 508 for the corresponding desktop profile.

The context data field 512 may comprise information or variables for identifying the various context states 404, 408, 412 and transitions between the contexts. Similar to the location data field 508, the context data field 512 may comprise information which maps a particular context to a particular desktop profile. Furthermore, the context data field 512 may contain the algorithmic expressions for determining a context of use based on a plurality of variables and/or data inputs.

The presentation parameters field 516 may comprise information for controlling the data displayed via a particular desktop profile, whether natively generated by the OS 144 or by the virtual machine 132. More specifically, for a virtual desktop profile the presentation parameters field 516 may define what information from the data store 128 can be used to generate a virtual desktop profile. It may also define the way in which (e.g., format) such data is presented.

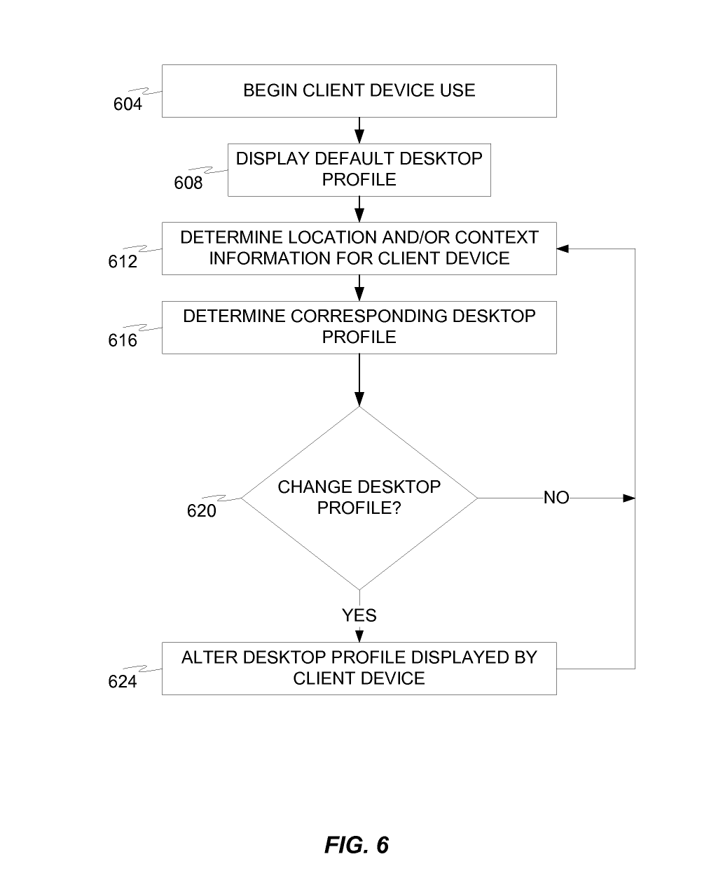

Referring now to FIG. 6, a method of controlling data displayed by a client device 104 based on location and/or context will be described in accordance with embodiments of the present disclosure. More specifically, the method is initiated when a client device 104 is used by a user (step 604). Upon initial use a default desktop profile may be displayed via the client device 104 (step 608). The default desktop profile may either be natively generated or may correspond to a virtual desktop profile.

Thereafter, information is determined regarding the location and/or context information for the client device 104, its user, and any other people within proximity of the client device 104 (step 612). The data structure 500 is then used along with the information obtained in step 612 to determine a desktop profile that is appropriate or required for display (step 616). More specifically, the location and/or context information is mapped to a desktop profile for the user of the client device 104.

Following the identification of the desktop profile in step 616, the context/presence module 152 determines whether to change the desktop profile displayed by the client device 104 (step 620). This may be answered negatively if the identified desktop profile corresponds to the currently displayed desktop profile (e.g., the default desktop profile), if the user was provided with an option to display a different desktop profile and the user declined, or if the client device 104 does not have a connection with server 112 and cannot receive a new virtual desktop profile. If the query is answered negatively, then the method returns to step 612.

On the other hand, if the client device 104 is to display the new desktop profile either along with the previously-displayed desktop profile or in lieu of the previously-displayed desktop profile, then the method continues by altering the desktop profile displayed by the client device 104 (step 624). The newly-displayed desktop profile may correspond to a natively generated desktop profile or a virtual desktop profile. Furthermore, the newly-displayed desktop profile may be the only desktop profile displayed by the client device 104 or it may be one of many desktop profiles displayed by the client device 104. Thereafter, the method returns to step 612.

In the foregoing description, for the purposes of illustration, methods were described in a particular order. It should be appreciated that in alternate embodiments, the methods and steps thereof may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
determining at least one of location and context information for at least one of a client device and a user of the client device;
mapping the at least one of location and context information to a desktop profile to be displayed by the client device; and
causing the client device to display the desktop profile.

2. The method of claim 1, wherein the desktop profile corresponds to a virtual desktop profile generated by a virtual machine running on a server within an enterprise network and wherein the server provides the client device with information for displaying the desktop profile via a Remote Desktop Protocol.

3. The method of claim 1, wherein the desktop profile corresponds to a desktop profile generated by an operating system of the client device.

4. The method of claim 1, wherein the context information is based, at least in part, on a network connection of the client device.

5. The method of claim 1, wherein the context information is based, at least in part, on whether any people other than the user are within proximity of the client device.

6. The method of claim 1, wherein the mapping step comprises comparing the determined at least one of location and context information to a data structure which maps a plurality of desktop profiles for a user to different location and context information.

7. The method of claim 6, wherein the plurality of desktop profiles comprise at least a first virtual desktop profile and at least a second virtual desktop profile and wherein the at least a first and second virtual desktop profiles comprise different presentation parameters.

8. A computer readable medium having stored thereon instructions that cause a computing device containing the computer readable medium to perform one or more functions, the instructions comprising:
first instructions configured to determine at least one of location and context information for at least one of a client device and a user of the client device;
second instructions configured to map the at least one of location and context information to a desktop profile to be displayed by the client device; and
third instructions configured to cause the client device to display at least one of the desktop profile and an option for displaying the desktop profile.

9. The computer readable medium of claim 8, wherein the desktop profile corresponds to a virtual desktop profile generated by a virtual machine running on a server within an enterprise network and wherein the server provides the client device with information for displaying the desktop profile via a Remote Desktop Protocol.

10. The computer readable medium of claim 8, wherein the desktop profile is generated by an operating system of the client device.

11. The computer readable medium of claim 8, wherein the context information is determined with one or more of the following data inputs: (i) client device location information; (ii) user presence information; (iii) information about usage of the client device; (iv) information about whether people than the user are in proximity of the client device; (v) information regarding whether people within proximity of the client device are trusted; (vi) information regarding the user's communication history; and (vii) information regarding the user's contacts.

12. The computer readable medium of claim 8, wherein the instructions further comprise fourth instructions configured to present the user with one or more icons that, only if selected, cause the client device to display the determined desktop profile.

13. The computer readable medium of claim 8, wherein the instructions further comprise an operating system and a Virtual Desktop Infrastructure module.

14. The computer readable medium of claim 8, wherein the instructions further comprise instructions configured to operate a virtual machine.

15. A communication system, comprising:
a context module configured to determine at least one of location and context information for at least one of a client device and a user of the client device, map the at least one of location and context information to a desktop profile to be displayed by the client device, and cause the client device to display at least one of the desktop profile and an option for displaying the desktop profile.

16. The system of claim 15, wherein the desktop profile corresponds to a virtual desktop profile generated by a virtual machine running on a server within an enterprise network and wherein the server provides the client device with information for displaying the desktop profile via a Remote Desktop Protocol.

17. The system of claim 15, wherein the context module compares the determined at least one of location and context information to a data structure which maps a plurality of desktop profiles for a user to different location and context information and wherein the plurality of desktop profiles comprise at least a first virtual desktop profile and at least a second virtual desktop profile and wherein the at least a first and second virtual desktop profiles comprise different presentation parameters.

18. The system of claim 15, wherein the context module is further configured to handoff the determined desktop profile from the client device to a second client device for display on the second client device.

19. The system of claim 18, wherein the client device and the second client device each display different desktop profiles, both of which are mapped to the user of the client device.

20. The system of claim 18, wherein the second client device only displays the determined desktop profile while the client device is within a predetermined area.
